(19) United States
(12) Patent Application Publication
(10) Pub. No.: US 2020/0112153 A1
(43) Pub. Date: Apr. 9, 2020

(54) Modular Container And System Of Modular Containers

(71) Applicant: Uncharted Power, Inc., New York, NY (US)

(72) Inventors: Deanna Kovalcin, New York, NY (US); Raya Islam, Slidell, LA (US); Phillip Steyn, Brackenfell (ZA); Fabian Bruegger, New York, NY (US); Jessica O. Matthews, New York, NY (US); Daniel Bish, Brooklyn, NY (US); Parth Singh, New York, NY (US); Lauren Tweel, Seattle, WA (US)

(21) Appl. No.: 16/596,362

(22) Filed: Oct. 8, 2019

Related U.S. Application Data
(60) Provisional application No. 62/743,455, filed on Oct. 9, 2018.

(51) Int. Cl. H02G 3/08; G02B 6/44; H02G 3/04; F16L 3/12; E01C 3/00

(52) U.S. Cl. CPC H02G 3/08; G02B 6/4451; E01C 3/006; F16L 3/12; H02G 3/04

(57) ABSTRACT

An embodiment of the container can include a top surface, a bottom surface and at least one side surface oriented between the top and the bottom surface. At least one side surface can define at least one exit port and at least one entrance port to the container. The container can define an internal cavity. The container can also include a load bearing member oriented on at least one of: the top surface, bottom surface or the at least one side surface. The container's top surface is load bearing, non-slip surface. First and second containers can be coupled in multiple variations and at multiple angles and power, data, fluid, or gas can be transferred and communicated between the two containers. The containers described herein can function as a replacement for standard flooring, sidewalks, and roads, or can seamlessly blend into the pre-existing environment.

### TECHNICAL FIELD

The embodiments of this disclosure relate generally to a modular container and more specifically a system of coupling the modular containers for various forms of transmission.

### BACKGROUND

The two common construction methods for power transmission systems, overhead lines and underground lines, fail to meet public and private needs for reliable, consistent, affordable, convenient energy. Many utility energy transmission systems are located above the ground and expose the energy transmission systems to damage and failure due to environmental factors. Thus, access to usable energy is often unreliable and/or unavailable, particularly in remote or disaster-prone areas of the world. Current underground energy transmission systems address this issue of vulnerability, but the resource barriers are too high for most parties to deploy, especially those that need them most. Therefore, there exists a great unmet need for reliable, consistent, affordable, convenient energy. Even systems that provide regularly consistent access to energy can fall victim to unplanned energy outages. Finding the source of the outage is often a resource consuming process, and prolonged outages bear harsh economic consequences. Thus, in addition to energy access, there also exists a need for an accurate, fast, reliable way to monitor energy transmission in order to detect and repair energy transmission line faults before end users are negatively impacted.

### SUMMARY

An aspect of an embodiment of the present invention improves systems for energy, data, and fluid transmission between modular systems of containers. The containers described herein can function as a replacement for standard flooring, sidewalks, and roads, or can seamlessly blend into the pre-existing environment. Wherever there is or can be ground, the containers can be installed. The containers create a piece of infrastructure, particularly a container for embedding technology or hardware in, partially above, or completely above the ground.

In an aspect of an embodiment of the present invention, the system may also include a series of proprietary protocols so that users of the network (or the network itself) can distribute energy or data automatically. The modular design of a container with embedded functionality that can be installed within the surface of the ground can reduce the cost of installing transmission lines for energy and/or data compared to conventional underground methods. Embedded sensors allow for precise monitoring and issue identification, so repairs can be addressed in hours instead of days, further lowering the cost of maintenance. Energy generation devices and components of a distributed data center can also be incorporated into each container, enabling the containers to function autonomously, and as such does not necessarily require linkage to a larger system to provide value to users.

In an aspect of an embodiment of the present invention, when connected to other containers, the system creates a decentralized network for energy access and/or data computing and storage that can adapt to the changing needs of the world around it. Features of the containers can include easy installation and repair, location identification for repair through smart monitoring, low cost, weather resistance, theft and tamper-resistance, aesthetic appeal, modularity and scalability, and durability, among others. The containers create a system that can also be leveraged for future technological advances, including embedded energy generation, scalable energy amalgamation, smart energy mesh networking, and/or dynamic energy distribution, among others. Embedded energy generation would allow energy harnessing devices to be directly integrated into the containers, housing the energy source directly in the container itself.

The present invention discloses a modular system for transmission and storage of power. An embodiment of the container features a top surface, a bottom surface and at least one side surface oriented between the top and the bottom surface. At least one side surface can define at least one exit port and at least one entrance port to the container. The container can define an internal cavity. The container can also include a load bearing member oriented on at least one of: the top surface, bottom surface or the at least one side surface.

Another embodiment for the container can include a top surface, a bottom surface and at least one side surface oriented between the top and the bottom surface. The at least one side surface can define at least one exit port and at least one entrance port to the container. The container can defines an internal cavity. The container can include a load bearing member oriented on at least one of: the top surface, bottom surface or the at least one side surface. The container can also include at least one conduit extending from the entrance port and the exit port. Also, the at least one conduit can be configured to transmit through the container.

An additional embodiment for a system of modular containers can comprise a first container with a first top surface, a first bottom surface and first container sides. The container sides can include a first left side, first right side, first top side, and first back side. The first container sides can be oriented between the first top and the first bottom surface. The container can include first container ports. The first container ports can include a first exit port or a first entrance port. Similarly, a second container can include a second top surface, a second bottom surface and second container sides. The second container can include a second left side, second right side, second top side, and second back side. The second container can be oriented between the second top and the second bottom surface. The second container ports can include second exit port or a second entrance port. In addition, at least one port of the first container ports is substantially aligned with the at least one port of the second container ports.

Other embodiments, features, and aspects of the disclosure are described in detail herein and are considered a part of the claimed disclosure. Other embodiments, features, and aspects can be understood with reference to the following detailed description, accompanying drawings and claims.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an exploded isometric view of the container.

FIG. 2 is an exploded isometric view of a first alternate embodiment of the container.

FIG. 3 is an exploded isometric view of a second alternate embodiment of the container.

FIG. 4 is an exploded isometric view of a third alternate embodiment of the container.

FIG. 5 is a top view of a schematic of the interior cavity of the container.

FIG. 6A-C is an isometric view of multiple configurations of coupled containers.

FIG. 7 is an isometric view of a plurality of containers coupled in series by conduit protectors (not visible).

FIG. 8A-8C is an isometric view of the plurality of containers depicting a change in elevation for the system of coupled containers.

FIG. 9A-9E is an isometric view of the plurality of containers depicting a change in angular rotation (in plane turns) for the system of coupled containers.

FIG. 10A-10F is an isometric view of the steps to install a series of containers in the ground.

### DETAILED DESCRIPTION

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The following description is provided as an enabling teaching of the disclosed articles, systems, and methods in their best, currently known embodiments. To this end, those skilled in the relevant art will recognize and appreciate that many changes can be made to the various aspects of the articles, systems, and methods described herein, while still obtaining the beneficial results of the disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “a gasket” can include two or more such gaskets unless the context indicates otherwise.

As used throughout, “substantially” with respect to a measure can refer to a range of values comprising +/−10% or +/−10 degrees. For example, substantially orthogonal, normal, or parallel can include embodiments, where the referenced components are oriented +/−10 degrees of being classified as orthogonal, normal, or parallel respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

The containers described herein can function as a replacement for standard flooring, sidewalks, and roads, or can seamlessly blend into the pre-existing environment. The containers can create infrastructure, particularly a conduit for embedding technology or hardware in the ground. The containers, however, can be partially above, or completely above the ground. The containers can be leveraged by a myriad of applications, including energy transmission, smart monitoring, and decentralized data centers. Once a set of containers is installed, it can serve as a system for a ubiquitous and on-demand source of energy and/or data that is accessible wherever and whenever power and/or data are needed. Similarly the system can serve as a ubiquitous and on-demand distribution method of the materials transported by the conduit (e.g. liquid, gas, etc.) The modular design of a container with embedded functionality that can be installed within the surface of the ground can reduce the cost of installing transmission lines for energy and/or data compared to conventional underground methods. Further, embedded sensors in the container can facilitate precise monitoring and issue identification, so repairs can be addressed in hours instead of days, further lowering the cost of maintenance.

Further, energy generation devices and components of a distributed data center can also be incorporated into each container. In such a configuration, the containers can function autonomously, and may not necessarily require linkage to a larger system to provide value to users. However, when connected to other containers, the system can create a decentralized network for energy access and/or data computing and storage that can adapt to the changing needs of the world around it.

Features of the containers can include easy installation and repair, location identification for repair through smart monitoring, low cost, weather resistance, theft and tamper-resistance, aesthetic appeal, modularity and scalability, and durability, among others. The containers create a system that can also be leveraged for future technological advances, including embedded energy generation, scalable energy amalgamation, smart energy mesh networking, and/or dynamic energy distribution, among others. Embedded energy generation would allow energy harnessing devices to be directly integrated into the containers, housing the energy source directly in the container itself. Scalable energy amalgamation allows for the efficient collection and storage of smaller packets of energy, often generated by multiple different sources. This allows for a larger, more consistent stream of energy to become available for use from one output anywhere throughout the container system due to its modular nature. With both embedded energy generation and scalable amalgamation housed within the containers, a complete solution for energy generation, storage, and transmission is provided. Smart energy mesh networking can utilize the network architecture that the containers are able to create, paired with intelligent communication and power prioritization protocols to efficiently and intelligently transmit energy. Short and long-range electricity, the Internet of Things, decentralized cloud computing, edge computing, wireless communication, and data utilization for block chain, virtual reality, augmented reality, and autonomous vehicles are a few industry examples that directly benefit from the container described herein and the systems built with them.

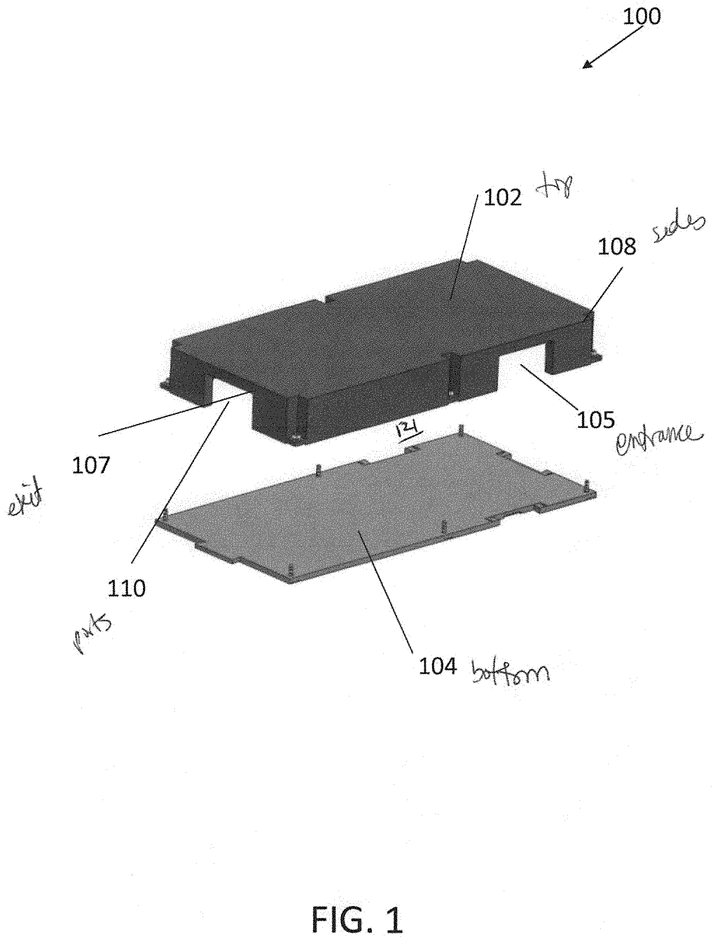

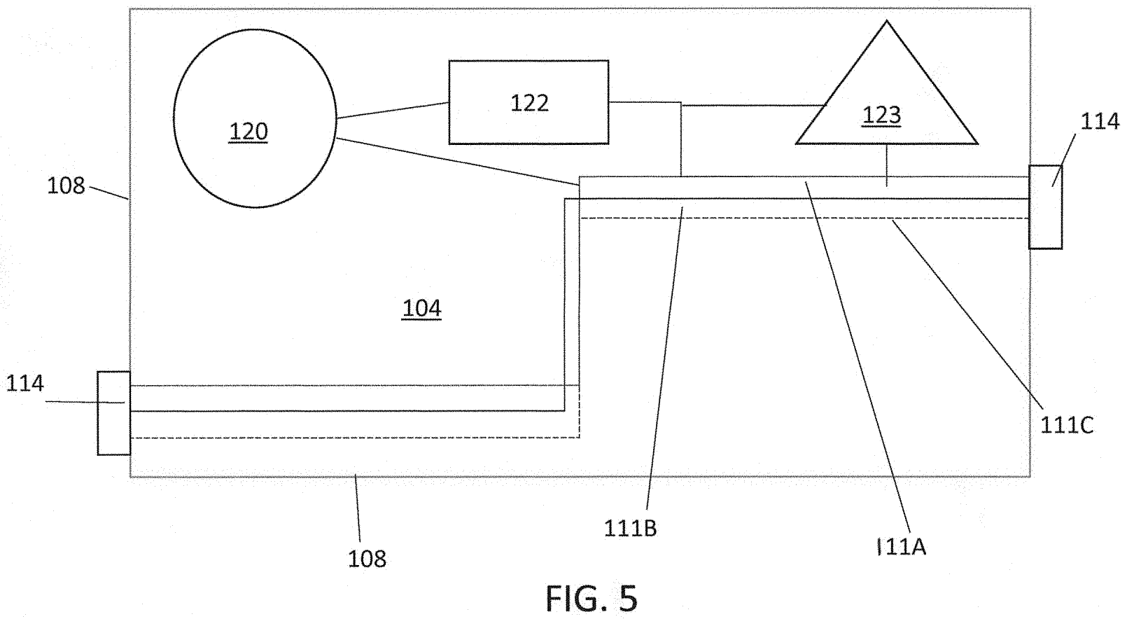

FIG. 1 illustrates an example of a container as described herein. FIG. 1 is an exploded isometric view of the container. The container 100 comprises a bottom surface 104 to form the base of the container; a top surface 102 to provide a ceiling for the container, which may also include side surfaces 108 to define an enclosure. The external side surfaces 108 extend downwards from all sides of the top surface 102 and they provide protection from debris or tampering efforts, and may or may not provide load bearing ability or function among others. The side surface can define a plurality of ports 110. Ports 110 are cutouts along the side surfaces 108 of the container sized to allow a conduit to extend through the ports. In one aspect, a plurality of ports 110 can be configured to function as an entrance port 105 on a right and left side of the container. The entrance port 105 is where the conduit enters the container 100. The exit port 107 is where the conduit exits the container. Further, the orientation of the entrance port 105 relative to the exit port 107 can be based on the direction of the data, energy, or fluid (mediums). In a further aspect, the container can be configured such that the direction of the mediums flowing through their respective conduit 111 can be uniform in direction or vary in direction. For example, the variable direction configuration, the electricity flow in the electricity conduit 111A can flow in one direction from entrance port 105 to exit port 107, while the fluid flow through the fluid conduit 111B can flow in the opposite direction (e.g. from exit port 107 to entrance port 105 in FIG. 1), as shown in FIG. 5. The entrance port may also be positioned along the same plane of the exit port, where the conduit would be positioned about that plane. Alternatively, as shown in FIG. 1, the conduit may enter on a side entrance port 105 and then exit out of a front or back exit port 107.

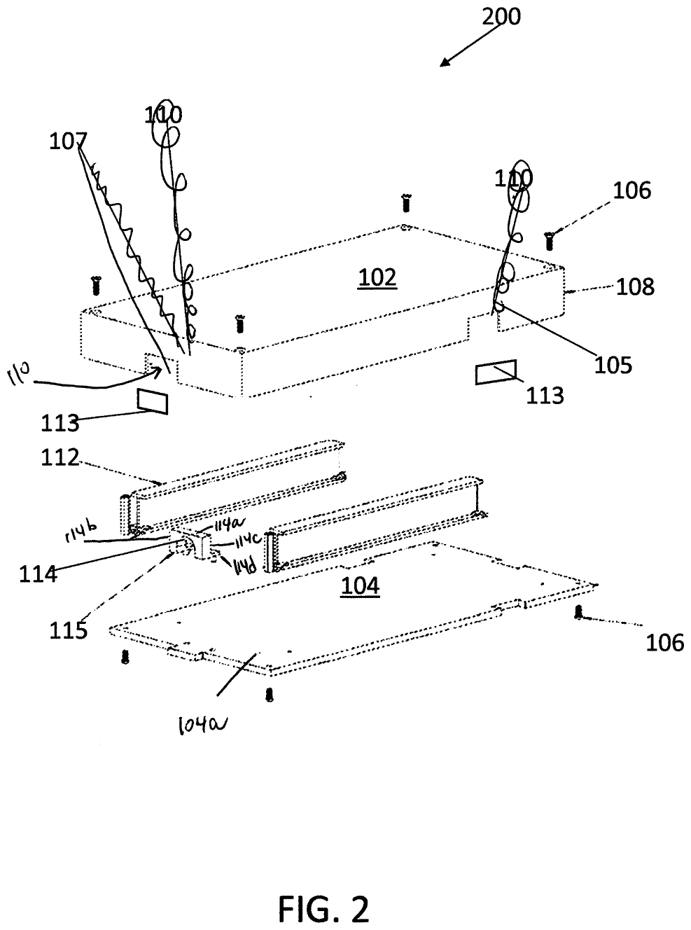

As shown in FIGS. 2, 3, and 4, the container can further include a conduit protector 114 to allow conduits 111A, 111B or 111C to transmit electricity, fluid, gas or data in and out of the container 100 and potentially provide a measure of protection therein; and fasteners 106 to couple the parts of the container together. For example, the fasteners may require a special tool to remove each fastener. The fasteners 106 can comprise any mechanism used to couple two components, which can include but not be limited to screws, bolts and nuts, nails, or rivets. The conduit protector 114 may define one or more apertures to allow passage across a barrier (e.g., in and out of the ports of the container). The conduit protector 114 protects, stabilizes, and provides access to the container's ports.

The conduit protector 114 utilizes the one or more openings or ports 110, 105 within the side surfaces to allow access into and/or out of the container 100. For example, the conduit protectors 114 allow conduits of various types to easily enter or exit the internal cavity 121 within the container. The bottom surface 104 may be laid down first, with the conduit, such as electrical cables then laid down on a top side 104a of the bottom surface, with the top surface 102 and side surfaces 108 which could be plates, installed after the conduits are positioned and potentially attached properly, depending on the application. Alternatively, an entire system of containers may be installed first, with the conduits such as electrical cables spooled through the set of connected containers. A version of the conduit protectors may also allow for the conduits to be accessed outside of the container, if the container is not connected to an adjacent container. For example, at minimum the first and last containers in a system of connected containers will have conduit protectors that allow for the beginning and end of the electrical cabling to be accessed externally without opening the containers, for connection or any other purpose. The conduit protectors may also prevent debris from entering the ports or openings, thus helping to prevent any damage to the electrical components within and between containers. In some embodiments, rather than laying down or spooling electrical cables through the entire system, the individual containers may have their own set of native electrical cables with connections extending from one or more external surfaces that can allow for containers to be coupled with (e.g., plugged into) one another directly as they are connected, to create a plug-and-play system.

For example, if multiple containers are connected, the conduit protectors may create an opening that allows for the individual electrical cables of each container to be connected to the electrical cables of adjoining containers. The container may have a plurality of conduit protectors. For example, the container may have 1, 2, 3, 4, 5, 6, 7, 8, 9, 10, 20, 30 or more conduit protectors. Alternatively or in addition, the container may have 30, 20, 10, 9, 8, 7, 6, 5 or fewer conduit protectors. Essentially, the conduit protector 114 is positioned between container where the conduits enter and exit their respective containers and their respective ports. The container may have as many, or more, openings in the side plate to accommodate the number of conduit protectors. In some instances, the container may have one or more openings in any other surface such as the bottom surface or top surface. The conduit protector 114 substantially aligns with the entrance port or exit port. A protector top surface 114a and a left protector side 114b and a right protector side 114c extends downwards from the top surface 114a. The conduit extends through the protector port 114 and guides and protects the conduit. The conduit protector 114 has a protector port 115 that substantially aligns with the entrance port or the exit port when the protector 114 is positioned on the bottom plate 104, top surface 104a. The protector 114 seals any gaps between two adjacent containers. The protector port 115 is a cut out or opening below the top surface and between the left and right sides, 114a, 114b of the protector 114. The protector base 114d connects with the top surface 104a of the bottom surface 104. The base 114d may be snapped, screwed or use any other known fastening mechanisms to secure or fit the protector 114 to the bottom surface 104.

The conduit protector 114 may also allow for the electric cable/wire, fiber optic filament or fluid pipes to be accessed outside of the container. In one aspect, the conduit 111B can facilitate transporting chemicals. In another aspect, the conduit protectors 114 may be configured to facilitate wireless transmission between the containers 100. In yet a further aspect to facilitate the wireless communication, the container 100, 200, may further comprise a transmitter and receiver to facilitate communication between two containers.

The fasteners may be screws 106 which can be tamper-proof or otherwise. Screws 106 may be positioned through holes on the base of the protector 114 and then threaded through the holes on the bottom surface to secure the protector to the bottom surface. The top and the base are interconnected with tamper proof fasteners, as seen in FIGS. 1-4.

In a further aspect, the container can contain fiber optic conduit 111C or other communication lines to provide internet access or telecommunication access. The conduit 111C is positioned in the internal cavity 121 defined as the inside area of the container between the top surface and bottom surface. The conduit protector 114 bridges the gap between conduits to keep conduits protected and keeps them in place during system assembly. The conduit protector 114 is durable and can help to ensure protection against environmental damage and/or ingress to the conduit traversing through two containers. The same conduit protector can be utilized in container systems that transmit electricity, light, data, solid, liquid, gas or any other mediums. The connectors were designed to snap into place and fit directly under container entrance or exit ports.

This modular type of container system is easier to deploy and therefore can be especially advantageous in remote parts of the world with limited or no internet access or in areas with high rates of natural disasters or other incidences that may interrupt typical communication lines or distribution pathways. In other examples, the container 200 may contain one or more microprocessors, microcontrollers, or other such device for computing, one or more device(s) for data storage, one or more sensors for data collection, or a combination thereof.

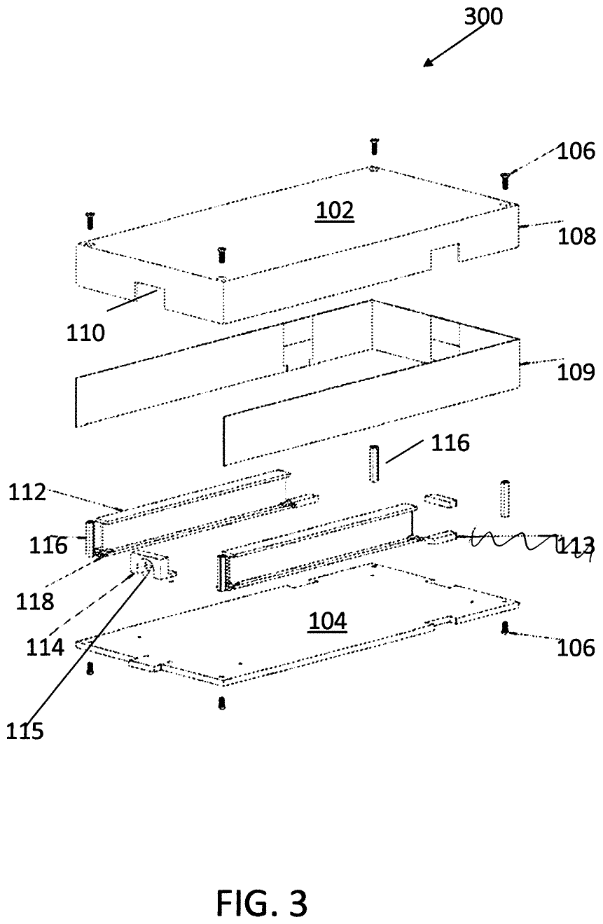

As shown in FIG. 2, the exploded view illustrates the layout of the container 200 comprises a bottom surface 104; a top surface 102; external side surfaces 108; conduit protectors 114 provide access to the container's internal cavity, defined as the inside space of the container between the top side and bottom side; and I-beams 112 and fasteners 106 to provide support for the container and increase its stability and robustness. As will be appreciated, any combination of the components mentioned above may be used to construct the containers described herein. In some instances, the container may have additional components (e.g., additional fasteners, supports, or a variety of other options). For example, the container 300, in FIG. 3 comprises an addition sidewall structure 109 to provide additional stability. The side surfaces 108 or additional sidewall structure 109 can mechanically couple to the top surface 102 and the bottom surface 104 to define the container. In some cases, the side surface(s) 108 can permanently connect to the bottom surface 104 and/or the top surface 102 to create one complete piece. In other cases, the side surfaces 108, 109 can temporarily connect to the bottom surface 104 and/or the top surface 102.

In some instances, the container can comprise fiber reinforced polymer (FRP), one or more plastics, one or metals, a combination thereof, or any other material. Fiber reinforced polymer (FRP) can be used to create an extremely durable container, as well as customizable aesthetics that can camouflage with its surrounding environment. For example, the top surface 102 can be structured to resemble pavement. While resembling pavement, the top surface 102 can be configured with texturing to ensure that it is a non-slip surface. In some aspects of the container, the top surface 102 can comprise fiber reinforced polymer for durability and structural stability. In a further aspect, the top surface 102 can be customized to blend into an existing environment or create a new appearance or environment within an existing environment. The top surface 102 may also comprise a protective transparent surface exposing underlying lighting devices (such as LED), in order to provide an interactive experience or navigation assistance. The top surface 102 is a load bearing member that can bear the weight of large objects and structures ranging from pedestrians to vehicles, for example. Load bearing member 102 supports ground infrastructure for indoor or outdoor vehicular, pedestrian, or other purposes.

In some cases, the top surface 102 is designed to withstand vertical forces of varying degrees. For example, the I-beam 112 can be integrated into the top surface 102 to allow the top surface 102 to also withstand lateral forces of varying degrees. In some embodiments, the container may comprise a plurality of I-beams. The plurality of I-beams 112 can function as a load bearing member for the container 200 and allows the container 300 to withstand the application of substantial force, vertical, lateral, or otherwise. The support provided by the plurality of I-beams 112 may allow for the placement of containers in a wide range of locations because of its high weight-bearing potential.

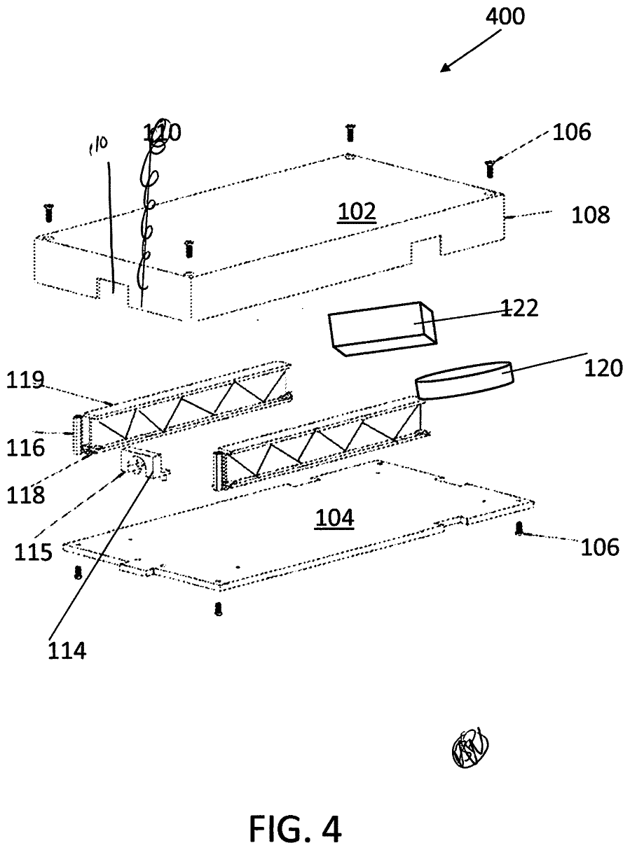

In FIG. 4, as shown in another aspect of the container 400, I-beams may also be replaced with any other support piece. For example, the a truss-type 119 member can be integrated into the top surface 102 or side surface 104 to support lateral, vertical or angled loads placed on the container. In yet a further aspect the container can implement a combination of I-beams 112, truss members 119, or supports 116. In yet a further aspect the load bearing members can be coupled to a respective surface instead of being permanently integrated into the surface. For example, the I-beam 112 and truss member 119 integrated can be selectively added or removed to customize the expected load. The I-beam could be coupled to the container 200, 300 or 400 using a plurality of fasteners including by not limited to Z-bracket 118, Velcro, straps, snaps, insets, screws or an adhesive.

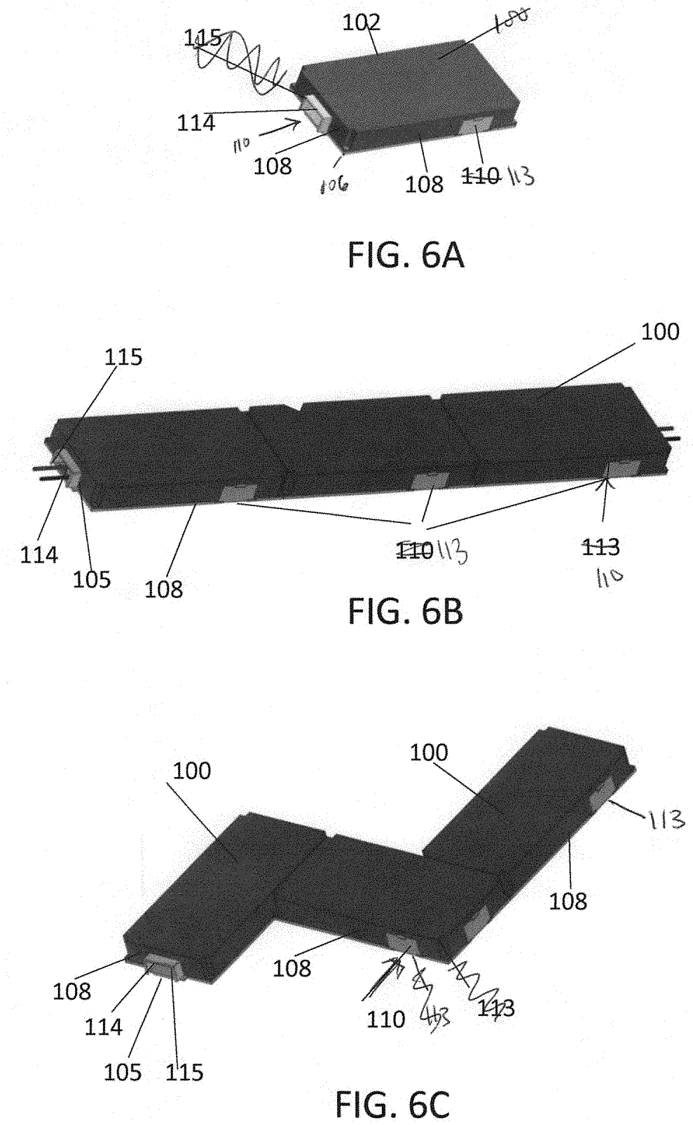

As discussed earlier, the one or more side surfaces 108 can have one or more ports in the side surfaces. The number of ports 110 can easily be adjusted depending on the pattern and/or layout that the containers intended for the installation. These ports 110 can be used for the passage of various conduits through the container 100. If the ports 110 are not being used they can be filled used the port plugs 113 in FIG. 6B to prevent debris or ingress from entering the container 100 or the top surface 102 sides can be sized to extend over the ports when the top surface is positioned over the walls to cover the ports. The port plugs 113 would be sized to at least fit in the open area of the ports 110.

The container 200 may further comprise conduit protectors 114. The conduit protectors 114 utilize the one or more ports within the side surfaces 108 to allow access for the conduit into and/or out of the container. This conduit protector 114 may be installed after the installation of the bottom surface 104 and before that of the top surface 102, with the conduit 111 such as electrical cable, fiber optic cables, or chemical piping. The top surface 102 and side surfaces 108 can be coupled to the bottom surface 104 after the conduit 111 is positioned.

The container may comprise one or more port plugs 113 in FIG. 6B. One or more port plugs 113 can close off any unused ports in the side surfaces 108, top surface 102, and/or bottom surface 104. Ports 110 in the side surfaces and/or bottom surface are incorporated so that containers 100 can be connected in parallel, in series, or both. The containers 100 can be connected in a linear or nonlinear manner. In some cases, some of the containers are connected in a linear manner, and some of the containers are connected in a non-linear manner. The containers can be connected in any pattern that provides benefit for the intended application. As shown in FIGS. 6A and 6B, one or more port plugs 113 may prevent debris and/or ingress from entering the container through unused ports.

Alternatively or in addition, the container system may include any type of complementary or one-way fastening mechanism. For example, the containers may have a mating device that can complete a form-fitting pair. The mating device can comprise a form-fitting convex component and the second conduit protector can comprise a form-fitting concave component, and/or vice versa. Alternatively or in addition, the mating devices can comprise other types of complementary units or structures (e.g., hook and loop, latches, snap-ones, buttons, nuts and bolts, etc.) that can be fastened together. In some instances, the mating devices can be fastened using other fastening mechanisms, such as but not limited to staples, clips, clamps, prongs, rings, brads, rubber bands, rivets, grommets, pins, ties, threads (e.g., screws), snaps, Velcro, adhesives (e.g., glue), magnets or magnetic fields, tapes, a combination thereof, or any other types of fastening mechanisms. The fastening can be temporary, such as to allow for subsequent unfastening of the parts without damage (e.g., permanent deformation, disfiguration, etc.) to either of the two connectors or with minimal damage. In other instances, the fastening can be permanent, such as to allow for subsequent unfastening of the two connectors only by permanently or semi-permanently damaging at least one of the two components.

One of the two mating devices, or both, can be temporarily or permanently deformed (e.g., stretched, compressed, etc.) and/or disfigured (e.g., bent, wrinkled, folded, creased, etc.) or otherwise manipulated when fastened to each other or during fastening. In some instances, one or both of the two mating devices can be cut into or pierced by the other when the two mating devices are fastened together. In some embodiments, a container can be made waterproof by adding in a seal, such as a gasket, on the interior of the container. The seal may be added as part of the container or as part of a more localized area within the container.

The container described herein comprises several features that allow for its use for a variety of applications, such as modularity and scalability, easy installation, weather resistant, tamper-resistant, aesthetic appeal, and durability, among others. In some instances, the container can be embedded into the ground. In some instances, the container can be partially embedded into the ground. In some instances, the container can be installed atop the ground. Embedding the container into the ground, partially or completely, can protect the contents of the container from safety hazards such as falling trees and harsh weather, secure the container to a fixed location, protect users from being exposed to high-risk electrical components, and integrate seamlessly into the aesthetics of the surrounding environment.

The modularity of the containers allows for greater customization in project planning, installation, for each project without hampering the functionality of installed containers. The modular and connectable containers reduce current installation costs and time for large infrastructure projects. Each container is designed to reduce the need for trenching, and to decrease the amount of ground preparation needed. In addition, each container may be outfitted with one or more mechanical connections, one or more electrical connections, or a combination thereof. As a result, installation of infrastructural projects using the modular and scalable containers can be completed in hours or days instead of the longer installation time comprising many days or weeks for some underground-based infrastructure projects. In addition, smaller portions of larger projects may be installed in segments, reducing the financial burden of the system at any given time.

In a further aspect, the container can be a component of an embedded energy transmission and storage system to facilitate energy transmission from one or more energy sources to one or more energy destinations. Provided herein is an energy transmission system that can be embedded above or below ground level. Partially embedding the energy transmission system in the ground provides several benefits including increased user safety, increased aesthetic appeal, increased speed of reparability, improved modularity and scalability, better financial feasibility, and easy installation.

As shown in FIGS. 6A, 6B and 6C, 7 and 8, the embedded energy transmission system can comprise one or more containers in an arranged formation. For example, the system of containers can be an energy transmission system that transmits energy from an energy source (such as an energy generating device 120 in FIGS. 4 and 5) to an energy destination (such as an energy drawing device or a load). The containers 100 can be laid in any pattern to connect two or more points as needed. The two or more points can be any combination of power generating (or energy harvesting) power supplies, energy-neutral devices, and/or energy drawing devices. In some cases, the containers can be leveraged to create infrastructure for full electrical micro-grids. The two or more points can be any infrastructure or device that is appropriate for the intended application.

The one or more containers of the energy transmission system can be modular, and can be configured to be connected to one another. Accordingly, the scale and functionality of the energy transmission can be increased or decreased as needed. The modularity allows for scaling of the energy transmission system over time. It also eliminates the need for additional major construction and/or damage to existing infrastructure.

The scalability of the system 700, 800 can also reduce the upfront costs of the energy transmission system. There is currently a large financial and resource barrier for traditional energy transmission and distribution systems. Since the energy transmission system described herein can be more easily scaled over time, the capital required for product purchase and installation can be spread out intermittently. In some cases, the container can be designed to reduce the time of installation compared with that of traditional forms of underground cabling installation. In some embodiments, the one or more containers and other components and accessories within the energy transmission system can be prefabricated. In some cases, they can be partially or fully pre-assembled prior to arriving at the installation site, saving on assembly time and difficulty.

The customization of the containers may extend beyond aesthetics and into structural applications. The containers can be used for infrastructure applications, such as roadways, pathways, sidewalks, flooring, and/or any other form of ground-based infrastructure for outdoor or indoor purposes. The modularity of the containers enables the system to be as small as a single container or as large as is necessary for the intended application.

As shown in FIG. 5, the one or more energy sources include energy harvesting devices 120 such as solar containers, wind turbines, kinetic energy harvesting devices, piezoelectric generators, triboelectric generators, or any other form of energy generation, transmission, storage, or harvesting. In some cases, the energy source is an electrical grid. In some cases, one or more converters may be used to step up or down the voltage at the point of the generation or elsewhere before or after it is to be transmitted. In some cases, one or more rectifiers may be used to rectify the power at the point of generation or elsewhere before or after it is to be transmitted.

In some cases, the kinetic energy harnessing devices 120 can be implemented directly in the containers themselves. For example, energy harvesting systems 120 can harvest kinetic energy exerted and dissipated by pedestrian and/or vehicular traffic above a surface in which the containers, described herein, are embedded. By implementing the energy source directly into the containers, the containers can become an integrated system for both energy generation and transmission. For example as shown in FIG. 5, the energy harvesting device 120 is coupled to the electrical conduit 111A and an energy storage device 122.

The one or more energy destinations can comprise low energy-consuming infrastructure such as indoor and outdoor lighting systems, street lighting systems, air conditioning (A/C) units, parking meter machines, mobile charging stations, and/or Wi-Fi kiosks, among others. In some cases, the one or more energy destinations may comprise high energy-consuming infrastructure such as residential buildings, hospitals, and schools, drone charging stations, among others. The energy destination can be any destination that includes an electrical load (e.g., an electronic device, or anything that uses, consumes, or stores electricity or energy).

In some cases, the containers can be designed such that individual transmission conduits are secured to each container and disconnected from one another, thus creating a plug-and-play system with the containers. As each container is laid in the ground, the next container may conveniently plug into the one adjacent to it. In this setup, the system can be easily scaled and/or the design can change at a later point in time with no damage to the containers and their transmission cables and with little effort, utilizing the upgradeability of the modular system.

In some embodiments, a plurality of protection systems may be included in the system to protect the system against over voltage, over current, or ground fault, among other problems. In some cases, the energy transmission components can be made waterproof by housing all electrical components in a waterproof container, such as a NEMA box or similar.

Described herein are energy systems for energy generation, storage, and transmission. In some embodiments, an energy system comprises a container as described herein. In some cases, the energy system comprises two or more containers. In some embodiments, an energy harvesting device, as described elsewhere, is integrated into at least one of the containers. Integration of the energy harvesting device into the container may require changes to the container structure or design. In some cases, the change to the container structure or design is minimal.

In some embodiments, the energy system may further comprise an energy storage system 122, as shown in FIG. 5. In some cases, the energy storage system 122 is integrated into at least one of the containers. The energy storage system can collect and store energy from the energy generator/harvester 120. The stored energy can be utilized for larger energy applications that require one consistent stream of power. For example, the energy storage system can be an electrochemical cell, lithium ion battery, rechargeable energy storage systems, capacitors, supercapacitors or ultracapacitors, fuel cells, other cells, or any other energy storage system (e.g., a system that stores potential energy that can be converted to electrical energy).

In some cases, the energy harvesting device 120 generates electrical power by harnessing the energy produced by devices. The energy may be harnessed from vehicular activity as described in PCT/US 18/49258. In some cases, the energy may be harnessed from pedestrian activity as described in U.S. Ser. No. 15/691,700. In some cases, the energy harnessing system may be integrated into an electrical grid or an external electrical system. In one embodiment, the electrical energy harvested from the energy harvesting devices is in pulsed form, with the duration of the pulse dependent on the vehicle and/or pedestrian weight and the matched optimization of the energy harvesting device with the inputs. This energy pulse is processed through temporary/permanent energy storage modules, passed through converters/inverters/rectifiers to optimize the waveform and amplitude to usable forms and, if needed, filtered to remove unnecessary harmonics and then fed to the AC/DC grid system. The ability to install an energy harnessing system any distance away from an electrical grid or an external electrical system allows for the creation of an energy system with unrestricted modularity and scalability, and ease of installation and repairs. Such systems for energy generation, storage, and transmission can be used to provide energy in remote parts of the world without electricity.

In some embodiments, one or more micro-generators 123 may be embedded in each container. In some cases, the micro-generator can harness energy from pedestrian and vehicular traffic. The use of embedded micro-generators provides several advantages. For example, the micro-generators mitigate spatial and/or geographical constraints typically encountered with the construction of power plants. In addition, the use of micro-generators within the containers provides users with reliable, self-sustaining, on-demand electricity.

Containers 100 can be coupled together to form a conduit transmission system. As shown in FIG. 6A, the container 100 has a top surface 102 with side surfaces 108 having ports covered with port cover 113. Fasteners 116 secure the top surface to the bottom surface. The conduit protector 114 is shown in the port 110.

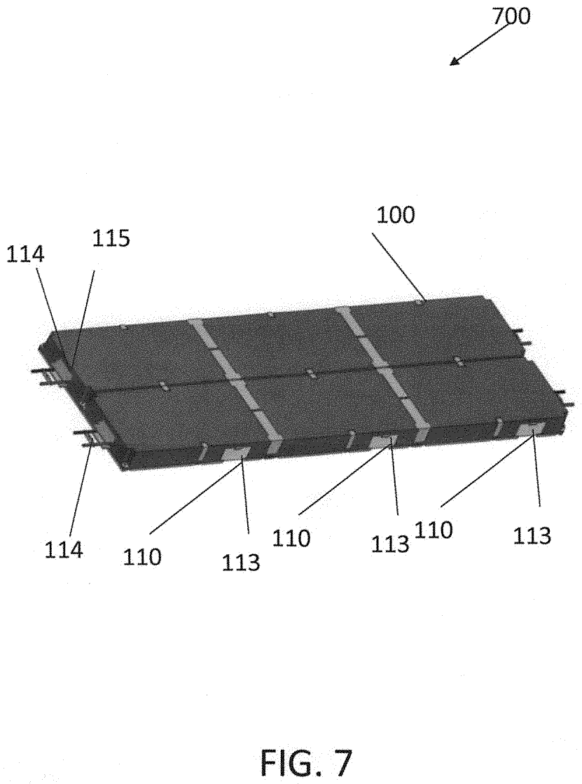

As shown in FIG. 6B-6C, the containers can be coupled to maintain the conduit directional flow. In a further aspect, the containers 100 can be coupled at the various ports 110 located along the side surface 108, as shown in FIG. 6C. The variable location of the ports 110 can provide additional flexibility in the structural orientation of the system as shown in FIGS. 6B and 6C. For example, as shown in FIG. 6C and FIG. 7, the ports 110 on the side surface 108 allow the installer to orient the plurality of containers 100 at an angle. As shown in FIG. 6C, the coupled containers can be oriented at an angle to be perpendicular to each other, such as 90 degrees. Similarly, the system of containers 100 can be oriented in a parallel configuration.

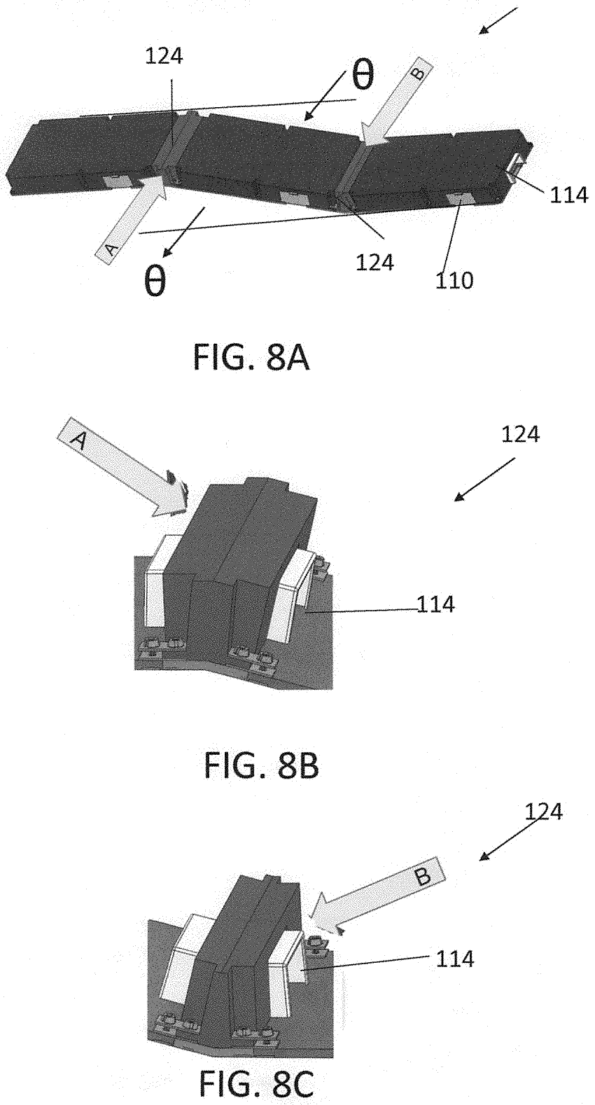

The systems in FIG. 6 and FIG. 7 can be installed with increased variability with the use of container connectors 124 in FIGS. 8A-C. The container systems in FIG. 6 and FIG. 7 are oriented such that they are in the same plane (e.g. lying flat). The surface on which they are installed can be flat. However, the embodiment shown in FIG. 8A depicts a system 800 of containers where the system can be installed with a change in elevation. For example, the container connector 124 can comprise a conduit protectors 114 for the various conduits in the container. The container connector 124 can maintain a uniform surface along the system of containers. The design enables conformation to ground topography while maintaining a connection between all container units without space gaps.

As shown in FIGS. 8A-8C, the containers 100 can form an angle theta (θ) when they are aligned on a hill or slanted surface, for example. A connector connector 124 can be positioned over the conduit protector 114 to allow the container to be positioned on an angle theta, uphill or downhill. The container connectors 124 can comprise a trapezoidal prism or wedge-shaped which allows the coupling of the conduit protectors 114 to orient a region of the entire system of system 800 at different elevation. The container connector 124 as shown by arrow A, can be positioned over the protector 114 to allow the containers to be fixed at an angle. The container connectors 124 is fastened to the top surface of the bottom plates of their respective containers. The connectors 124 permit pitch uphill or downhill, rotation about the X axis or they permit yaw; lateral turns rotation about the Y-axis. The connector 124 comprises a cavity or channel continuing the network of conduits provided by the containers.

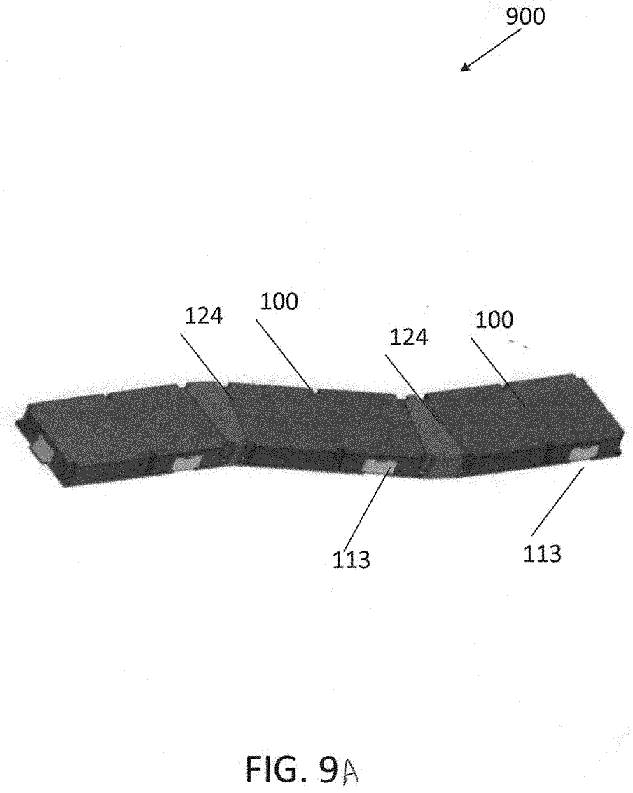

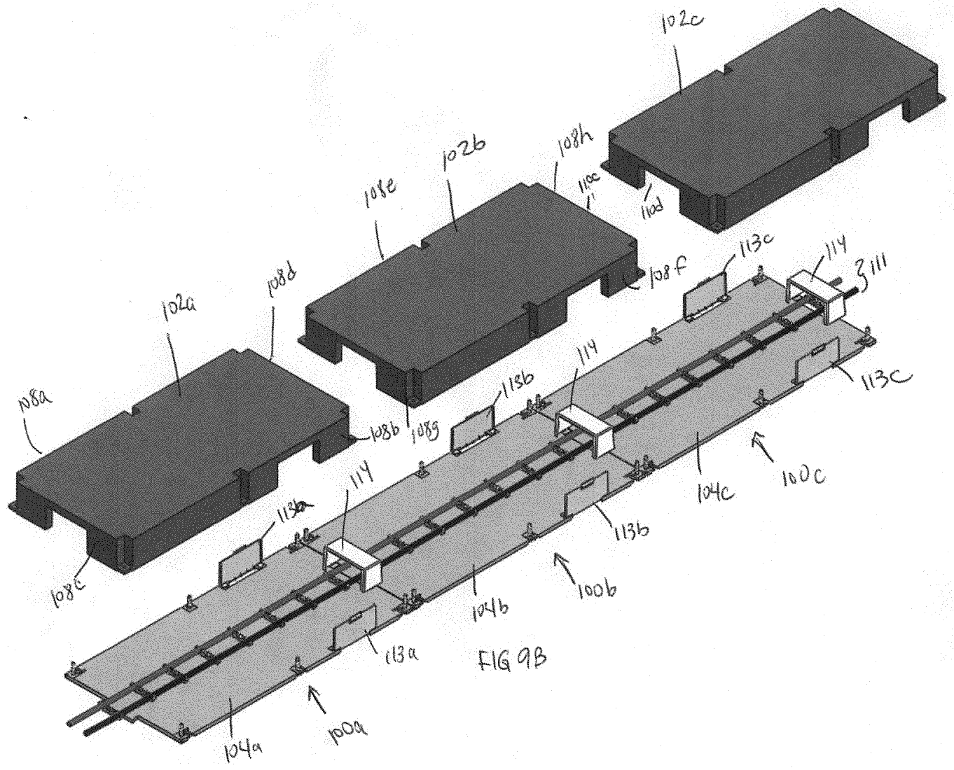

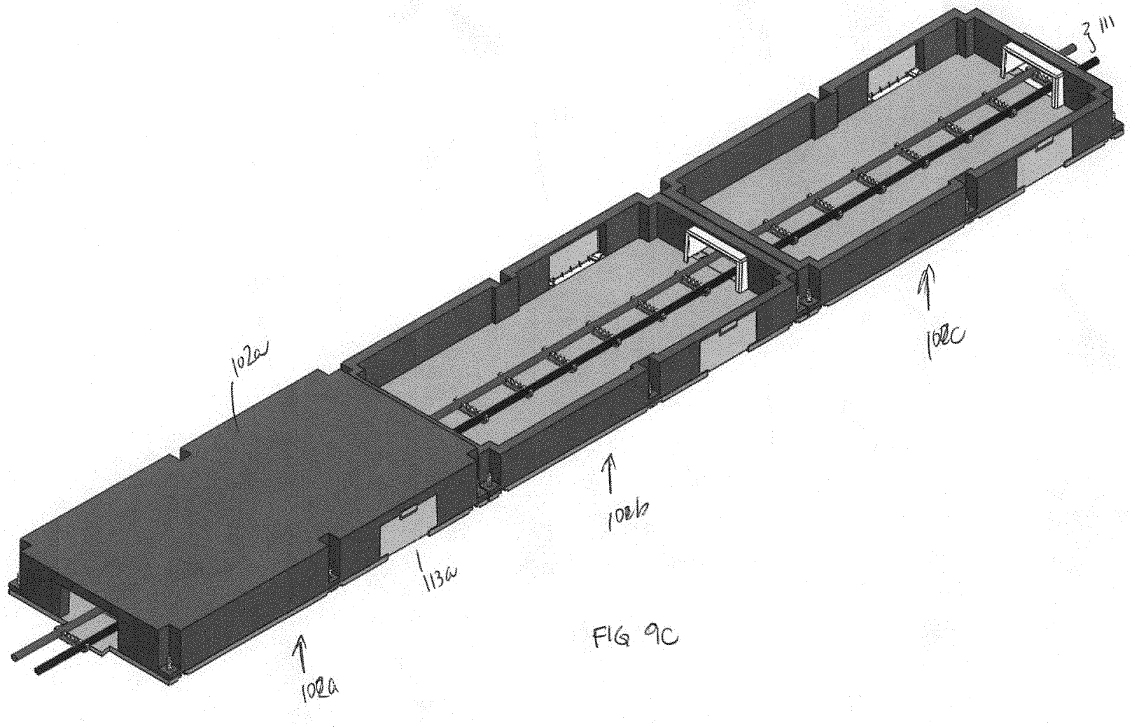

It is further considered that the container connector 124 can vary the ratio to the two bases of the trapezoidal prism to increase or decrease the angle theta (θ). The container connectors 124 can be attached to one another to create larger increments of elevation. For example, multiple container connectors can be coupled to each other. Similarly in FIG. 9A, container connectors can enable non-90-degree turns parallel to the ground infrastructure axis. The container connectors possess similar properties to the containers in that they are load bearing, non-slip, easy to install, weather-resistant, tamper-resistant, aesthetically appealing, and durable, among others. In addition, they may or may not house electronics components inside. The container connectors 124 can also be attached to one another to modify the turn angle in increments. The surface of the connectors 124 can be flush with the top surface of the containers when they are positioned.

FIG. 9A-9F is an isometric view of the plurality of containers depicting a change in angular rotation (in plane turns) for the system of coupled containers. As shown in FIG. 9B, three containers, 100a, 100b and 100c are aligned. Each container has a top surface 102a, 102b and 102c. The containers have port covers 113a, 113b, 113c along the side edges of the container, extending upwards towards the top surface from the bottom surface. Conduits 111 are laid along the top of the bottom sides 104a, 104b, 104c. Conduit protectors 114 are on the top of the bottom sides of adjacent bottom sides. The conduit protector 114 are on the surface of top of 104b and 104c, for example. And the protector 114 is also on the top of the bottom sides 104a and 104b. Extending from the top surfaces 102a, 102b and 102c are side surfaces. First container, container 100a has a left side 108a, right side 108b, a front side 108c and a back side 108d. Second container, container 100b has a left side 108e, right side 108f, 108g a front side and a back side 108h. The sides of the containers have ports or cutouts that can serve as entrance or exit ports for the conduits.

The port of the first container port is substantially aligned with the at least one port of the second container port, when the containers are aligned. As shown in FIG. 9A, port 110a of a first container 100a is substantially aligned with the port 11b of a second container 100b. The side port of one container can align with the front or back port of a second container as shown in FIG. 9D. Or, the ports can be aligned front to back where the back of one port aligns with the front port of a second container, as shown in FIG. 9B where 110c aligns with 110d. The first and second containers can be parallel to the ground infrastructure axis. Alternatively, the first and second containers can be perpendicular to the ground infrastructure axis. FIG. 9C shows containers 100a, 100b and 100c aligned showing the cover 102a on container 100a and the port cover 113a concealing the port 110a. FIG. 9D shows an alternative layout of the containers 100a, 100b and 100c where the second container top surface 102b and second container sides 108b show fastening mechanisms positioned to align with fastening mechanisms on the bottom side of the containers. The ports where the conduit will not pass through are closed with port covers 113. In FIG. 9E, the containers arranged in 9D shows the first container 100a with a top surface 102 and port 110. The internal cavity 121 is also shown in FIG. 9E.

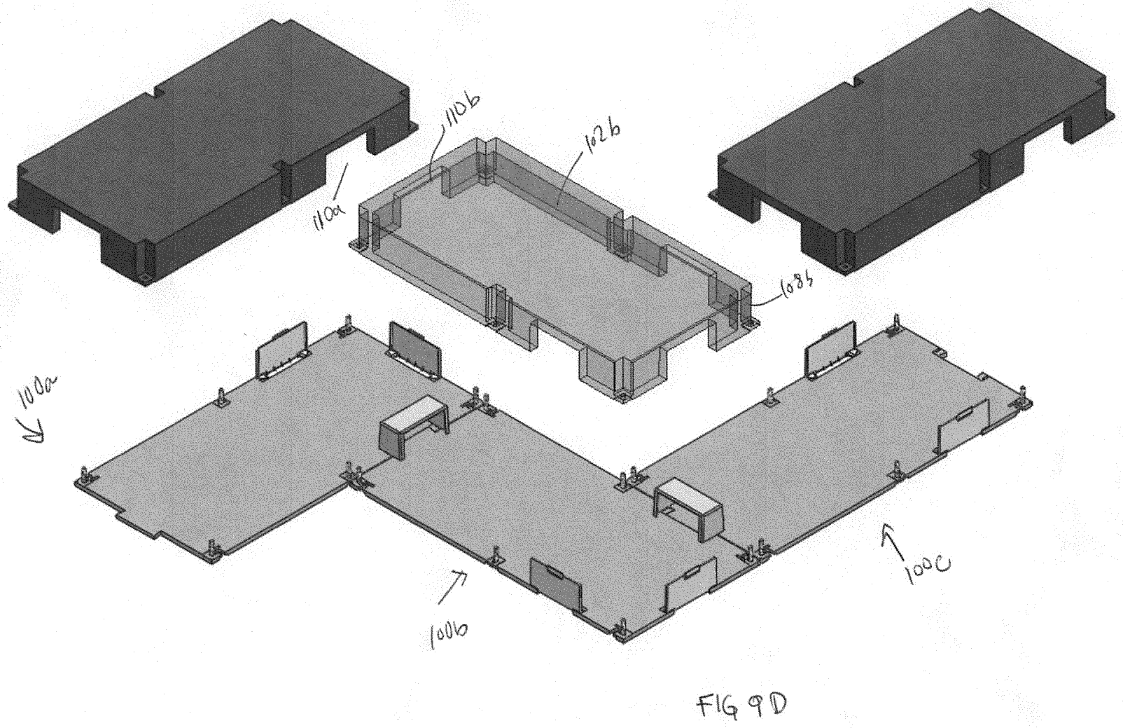

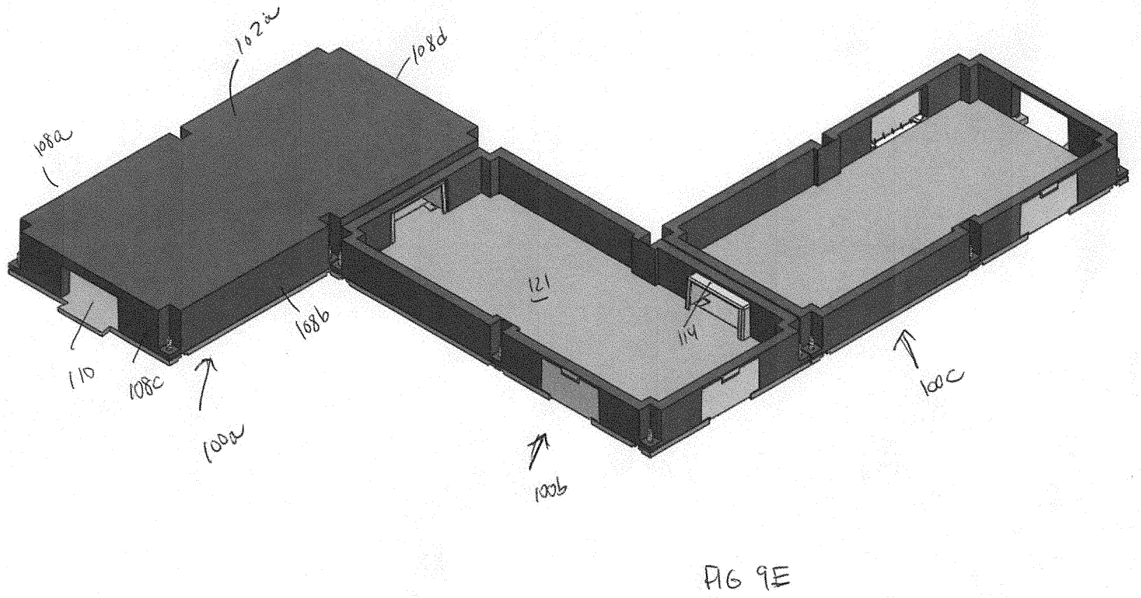

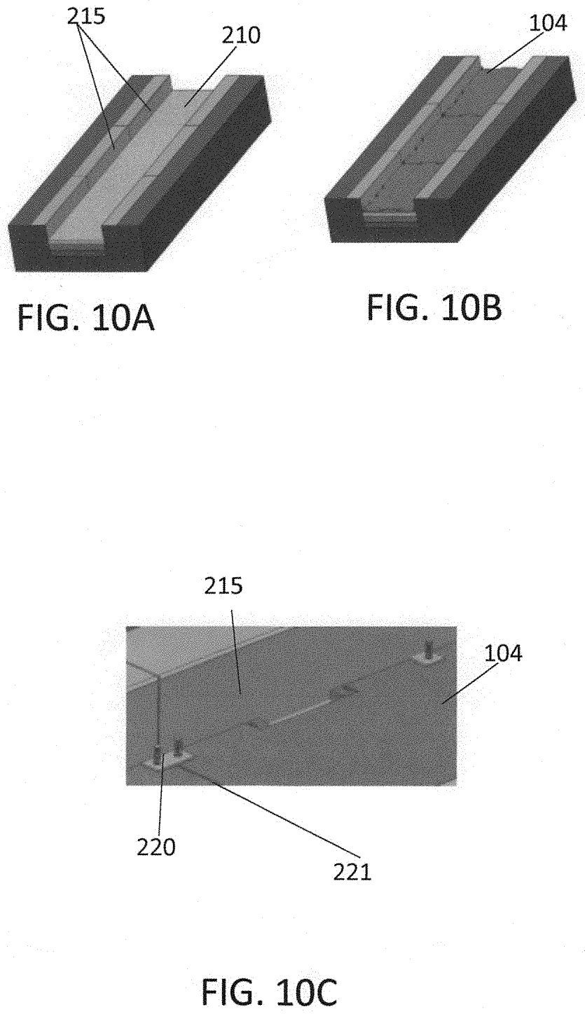

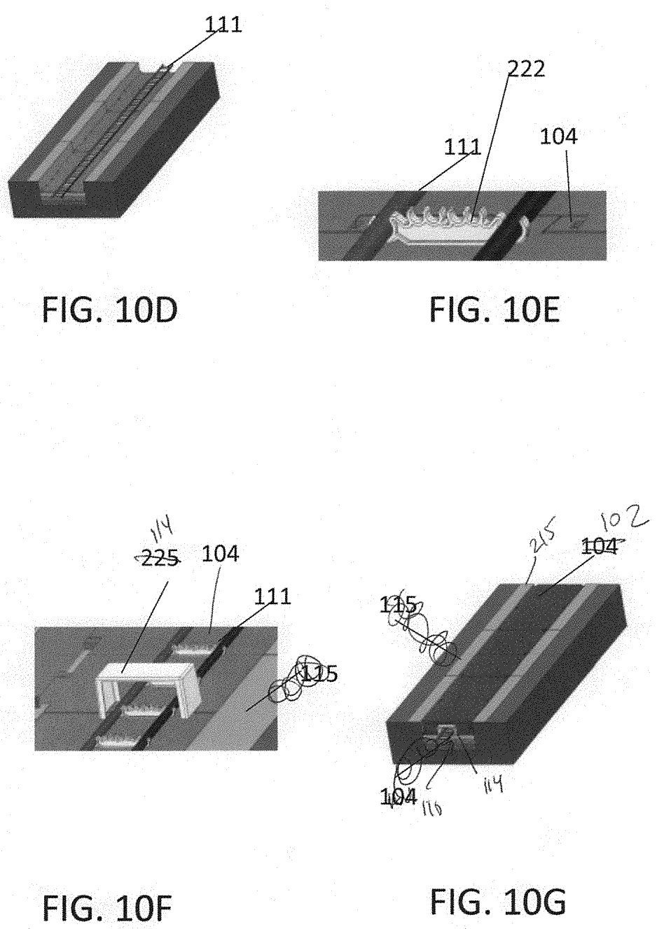

As depicted in FIG. 10A-10F an exemplary set of steps for installing the container 100 is depicted. As shown in FIG. 10A, a trough 210 can be dug into the ground with dimensions consistent with the container 100 to be installed. In a further aspect, installation can also involve installation sides 215 which are bearings that provide additional support along the sides of the trough. The trough is leveled, as needed. As shown in FIG. 10B, the bottom surface 104 can be placed in the trough 210 to initiate constructing the modular container 100. As shown in FIG. 10C, the bottom surfaces can be coupled together at the interface 221 between the two containers. When coupling the containers 100, the containers can be joined using fasteners 220. FIG. 10D depicts conduit 111 being laid on the container bottom 104. In a further aspect, as shown in FIG. 10E, the conduit 111 can be oriented for uniformity using a spacer 222. The spacer 222 is placed on the top surface of the bottom and has multiple graspers to receive the conduits and keep the organized and separate.

As shown in FIG. 10F, a conduit protector 114 can be installed onto a first bottom surface of a first container and a second bottom surface of a second container so that the protector contacts both the first and second bottom surfaces. In a further aspect, the side surfaces 108 are positioned along the side walls of the trough. Further as shown in FIG. 10G, the top surface 102 can be placed to cover the container 100. This installation can be repeated to align numerous containers that receive the conduit and transmit throughout.

While certain embodiments of the disclosure have been described in connection with what is presently considered to be the most practical and various embodiments, it is to be understood that the disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosure, including the best modes, and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A container comprising:
a top surface, a bottom surface and at least one side surface oriented between the top and the bottom surface,
wherein the at least one side surface defines at least one exit port and at least one entrance port to the container, and
wherein the container defines an internal cavity;
and a load bearing member oriented on at least one of: the top surface, bottom surface or the at least one side surface.

2. The container of claim 1, further comprising a first conduit extending from the entrance port to the exit port wherein the first conduit transmits through the container at least one of: electricity, light, data, solid, liquid, or gas.

3. The container of claim 2, further comprising at least one conduit protector adjacent to the entrance port or the exit port, wherein the at least one conduit protector comprises a protector port that substantially aligns with the entrance port or the exit port.

4. The container of claim 3, wherein the at least one conduit protector further comprises a protector top surface and a left protector side and a right protector side extending from the top surface.

5. The container of claim 3, wherein the first conduit extends through the protector port, wherein the protector port guides and protects the first conduit.

6. The container of claim 2, wherein the first conduit comprises a chemical component.

7. The container of claim 1, wherein the container comprises a data system to collect a conduit data of the first conduit.

8. The container of claim 1, wherein the load bearing member supports ground infrastructure for indoor or outdoor vehicular, pedestrian, or other purposes.

9. A container comprising:
a top surface, a bottom surface and at least one side surface oriented between the top and the bottom surface,
wherein the at least one side surface defines at least one exit port and at least one entrance port to the container, and
wherein the container defines an internal cavity;
a load bearing member oriented on at least one of: the top surface, bottom surface or the at least one side surface; and
a conduit extending from the entrance port and the exit port,
wherein the conduit is configured to transmit through the container.

10. The container of claim 9, wherein the conduit transmits through the container at least one of: electricity, solid, liquid, or gas.

11. The container of claim 9, further comprising at least one conduit protector adjacent to the entrance port or the exit port, wherein the conduit protector comprises a protector port that substantially aligns with the entrance port or the exit port.

12. The container of claim 9, wherein the top surface comprises a non-slip external surface.

13. The container of claim 9, wherein the load bearing member supports ground infrastructure for indoor or outdoor vehicular, pedestrian, or other purposes.

14. A system of modular containers comprising:
a first container with a first top surface, a first bottom surface and first container sides comprising a first left side, first right side, first front side, and first back side,
wherein the first container sides are oriented between the first top and the first bottom surface;
first container ports comprising a first exit port or a first entrance port;
a second container with a second top surface, a second bottom surface and second container sides comprising a second left side, second right side, second front side, and second back side,
wherein the second container sides are oriented between the second top and the second bottom surface;
second container ports comprising second exit port or a second entrance port;
wherein at least one port of the first container ports is substantially aligned with the at least one port of the second container ports.

15. A system of modular containers of claim 14 further comprising a container connector configured to couple the first container and the second container, wherein the container connector is configured to adjust an angular orientation between the first and second containers.

16. A system of modular containers of claim 14, wherein the first exit port is substantially aligned with the second entrance port so that the first and second containers are parallel to the ground infrastructure axis.

17. A system of modular containers of claim 14, wherein the first exit port is substantially aligned with the second entrance port so that the first or second containers are perpendicular to the ground infrastructure axis.

18. A system of modular containers of claim 14, further comprising at least one conduit protector adjacent to the at least one port of the first container ports that is substantially aligned with the at least one port of the second container ports.

19. The system of modular containers of claim 18, further comprising a conduit transmitting through the first container and the second container, wherein the conduit is positioned through the first exit port to the second entrance port.

20. The system of modular containers of claim 19, wherein the container comprises a data system to collect a first data of the conduit and a second data of the conduit as the conduit transmits through the first and second containers, respectively.
